(19) United States
(12) Patent Application Publication
(10) Pub. No.: US 2011/0084495 A1
(43) Pub. Date: Apr. 14, 2011

(54) VERTICAL AXIS WIND TURBINE

(75) Inventors: Gordon Y.S. Wu, Hong Kong (CN); Thomas J. Wu, Hong Kong (CN); Carol Ann Wu, Hong Kong (CN)

(73) Assignee: HOPEWELL WIND POWER LIMITED, Tortola (VG)

(21) Appl. No.: 12/918,878

(22) PCT Filed: Apr. 24, 2009
(86) PCT No.: PCT/IB2009/005366

§ 371 Date: Dec. 30, 2010

(30) Foreign Application Priority Data
Apr. 24, 2008 (HK) 08104604.2
Apr. 25, 2008 (HK) 08104651.4
Jul. 14, 2008 (HK) 08107704.4
Aug. 11, 2008 (HK) 08108816.7
Apr. 9, 2009 (HK) 09103365.2

(51) Int. Cl. F03D 9/00; F04D 29/38

(52) U.S. Cl. 290/55; 416/203

(57) ABSTRACT

A vertical axis wind turbine has a stationary circular core and a rotor rotatably supported about the stationary core. The rotor has a radially extending rotor arm with a wind engaging blade locate at its distal end. The blade has at least two straight blade sections of which at least one blade section is inclined obliquely at a first angle.

### FIELD OF THE INVENTION

The current invention relates to wind generators, also called wind turbines, and more particularly to vertical axis wind generators.

### BACKGROUND

The inventors have previously proposed in International Patent Application PCT/IB2008/003521 filed 17 Dec. 2008, the entire contents of which are incorporated herein by reference, a shaftless vertical axis wind turbine in which the rotor comprises a fully trussed tubular carousel structure rotatably supported about a stationary vertical hollow core. Aerofoil shaped rotor blades are located at the distal ends of the rotor arms. Aerodynamic forces generated by airflow over the rotor blades causes the carousel to rotate about the core.

The rotor arms can be either tie-stayed rotor arms that extends radially from the carousel or a pair of upper and lower trussed rotor arms that extend radially from the carousel with a tie-stay arm extending diagonally in between each pair of upper and lower trussed rotor arms. The tie-stay arm extends diagonally from the inner end of the upper radial trussed arm to the distal end of the lower radial trussed arm. The tie-stay component of the rotor arms is designed to enhance the structural strength of the rotor arms to counter the gravitational and centrifugal forces acting on the blades. However, such tie-stay components will cause drag and disturbance to the air flow of the inner side of the aerofoil blade and the air flow in between the aerofoil blade and the carousel.

It is envisaged in PCT/IB2008/003521 that the rotor arms could be enclosed by aerodynamically shaped skin, which effectively convert the rotor arms into aerofoil blades or wings. One common problem of vertical wind turbines is that the rotor may not, or at least have difficulty, self starting in low wind conditions. Further, in order to optimize power generation and to protect the turbine, the speed of the rotor needs to be controlled and in certain situations the generator needs to be stopped. Known wind turbines use pitch and stalling devices to control rotor speed.

It is envisaged in PCT/IB2008/003521 that movement of the rotor is used to mechanically turn a generator located with the core tower by means of gearing located adjacent lower lateral thrust rollers of the carousel. The gearing comprises of a pair of gears rotatably located in an opening in the core tower wall. A smaller gear is engaged by a ring gear located below a thrust roller about the inner periphery of a lower annular member of the carousel and rotates the smaller gear with movement of the rotor. The smaller gear is fixed with the larger gear which engages a generator gear to turn the generator.

The inventors have sought to advance on the previous design.

### SUMMARY OF THE INVENTION

There is disclosed herein a vertical axis wind turbine comprising a stationary circular core. A rotor is rotatably supported about the stationary core and has a radially extending rotor arm. A wind engaging blade is located at a distal end of the radially extending rotor arm. The blade comprising at least two straight blade sections of which at least one blade section is inclined obliquely at a first angle.

There is also disclosed herein an electric generator set located with the stationary core, and a torque transmission system for transferring rotational torque from the rotor to the generator set. The torque transmission system includes a pair of cooperating gears driving a torque transmission shaft coupled with the generator set. The torque transmission shaft includes an axially movable coupling and a pivotal coupling.

Accordingly, the invention provides a vertical axis wind turbine according to any one of the appended claims.

Further aspects of the invention will become apparent from the following description which is given by any of example only.

### BRIEF DESCRIPTION OF THE DRAWINGS

Exemplary embodiments of the present invention will now be described by way of example only and with reference to the accompanying drawings, in which:

FIG. 1 is a perspective illustration of a first embodiment of a vertical axis wind turbine according to the invention,

FIG. 2 is a section elevation illustration of the first embodiment of a vertical axis wind turbine,

FIG. 3 is a perspective illustration of a second embodiment of a vertical axis wind turbine according to the invention,

FIG. 4 is a section elevation illustration of the second embodiment of a vertical axis wind turbine,

FIG. 5 is a perspective illustration of a third embodiment of a vertical axis wind turbine according to the invention,

FIG. 6 is a section elevation illustration of the third embodiment of a vertical axis wind turbine,

FIG. 7 is a perspective illustration of a fourth embodiment of a vertical axis wind turbine according to the invention,

FIG. 8 is a section elevation illustration of the fourth embodiment of a vertical axis wind turbine,

FIG. 9 is a section plan illustration at upper radial rotor arm level of a vertical axis wind turbine according to the invention,

FIG. 10 is a section plan illustration at lower radial rotor arm level of the vertical axis wind turbine,

FIG. 11 is a part section elevation illustration of the part identified as ‘detail A’ in FIG. 2,

FIG. 12 is a part section elevation illustration of the part identified as ‘detail B’ in FIGS. 4, 6 and 8,

FIG. 13 is a cross section illustration through an rotor arm showing flaps for disruption air flow over the rotor arm, and

FIG. 14 is a perspective illustration of the top surface of the rotor arm showing the flaps.

### DESCRIPTION OF THE CURRENT INVENTION

In the accompanying figures there is depicted various embodiments of a shaftless vertical wind turbine according to the invention. The wind turbine comprises three basic functional parts. These are a vertical supporting structure 1, at least one wind driven rotor 2 located about the structure and a generator 3 driven by the rotor for the generation of electricity. The wind turbine may comprise a single rotor, as depicted, or in yet further embodiments not depicted may comprise a plurality of vertically stacked independently rotating rotors. The rotors are stacked vertically one above the other and are each coupled with a corresponding torque transmission and generation units located with the vertical supporting structure.

The vertical supporting structure comprises a vertically extending cylindrical tower forming a stationary core 4 of the wind turbine. The core tower 4 extends the full height of the wind turbine and may be caped with a roof (not shown) that is either flat, pitched or domed. In the preferred embodiment the core tower 4 is constructed with two concentric circular walls 5, 6 having a void 7 between them. A plurality of ribs (not shown) extend vertically within the void 7 at spaced apart circumferential locations connecting the inner and outer walls 5, 6. The vertical ribs separate the void 7 between the walls into a plurality of cells. This double wall cellular structure gives the tower 4 strength to withstand large lateral forces generated by wind. The area within the inner wall of the core is generally hollow creating a large centre void 8 within the structure. The core tower 4 is made from reinforced concrete and may be constructed using known building construction techniques.

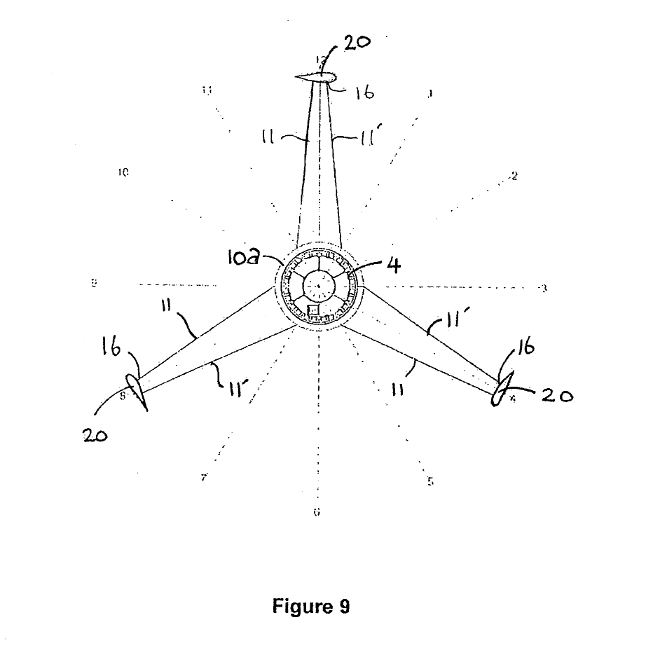

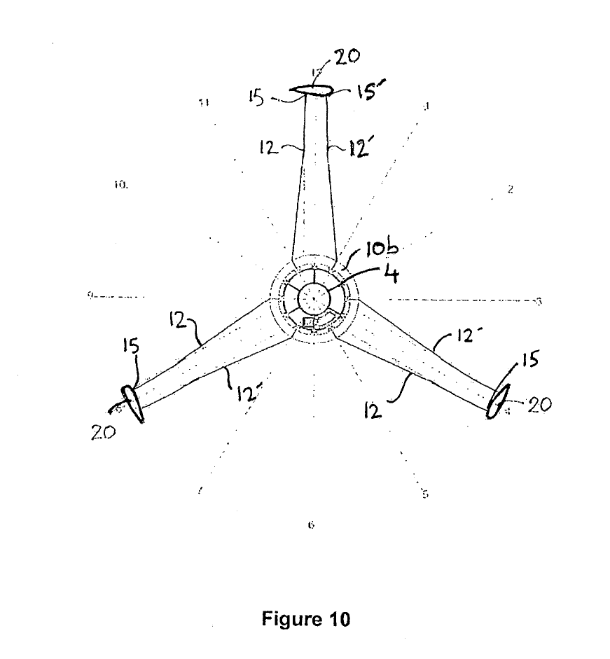

The rotor 2 comprises a fully trussed tubular carousel structure 10 located and freely rotatable about the core tower 4. Pairs of upper and lower trussed rotor arms 11, 11′ and 12, 12′ extend radially from the carousel 10. In between the upper and lower trussed arms 11, 12 there is diagonal tie-stay arm 13 extending from the inner, proximal, end 14 of the upper radial trussed arm 11 to the outer, distal, end 15 of the lower set of radial trussed arm 12. As can be viewed in FIGS. 9 and 10 the pairs of upper (11, 11′) and lower (12, 12′) radial arms are tapered from the carousel 10 towards the distal ends 15, 16 to resist shear, bending and torsion stress cause by rotational torque of the rotor. At the distal ends 15 of each pair radial truss arms is a generally aerofoil shaped lift-type blade 20. In the preferred embodiment there are three symmetrically spaced pairs of trussed radial arms and blades, however this is not meant to limit the scope of use or functionality of the invention. The skilled addressee will appreciate that 2, 4, 5, 6 or more blades may be used with varying degrees of power and efficiency.

The rotor is rotatably supported about the core tower 4. As described in PCT/IB2008/003521 filed 17 Dec. 2008, there are sets of wheels 31 or rollers located circumferentially about the inner edges of the carousel that run on tracks affixed or integrated in to the core 4. Upper wheel or roller sets 30 provide vertical and horizontal lateral support to the rotor against the outer periphery of the concrete core tower 4. Lower thrust rollers 32 provide lateral support for the lower part of the carousel against the outer periphery of the core tower 4. The rotor 2 rotates about the core tower 4 under the effect of wind interaction with the aerofoil shaped blades 20 at the distal ends of the rotor arms 11, 12.

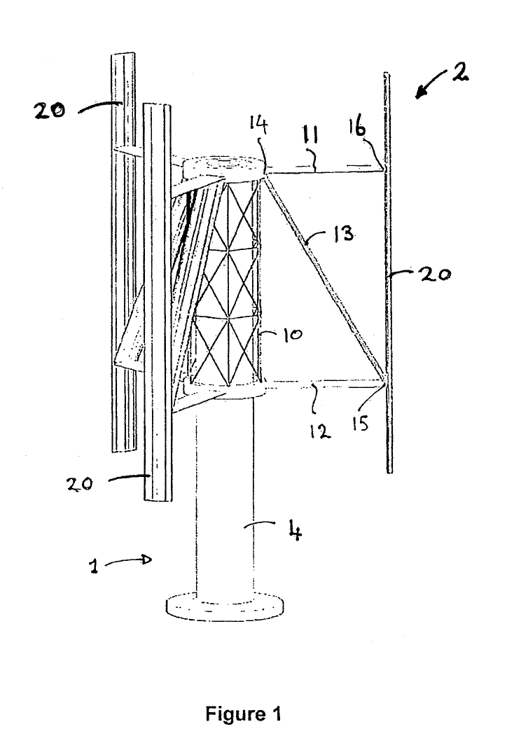

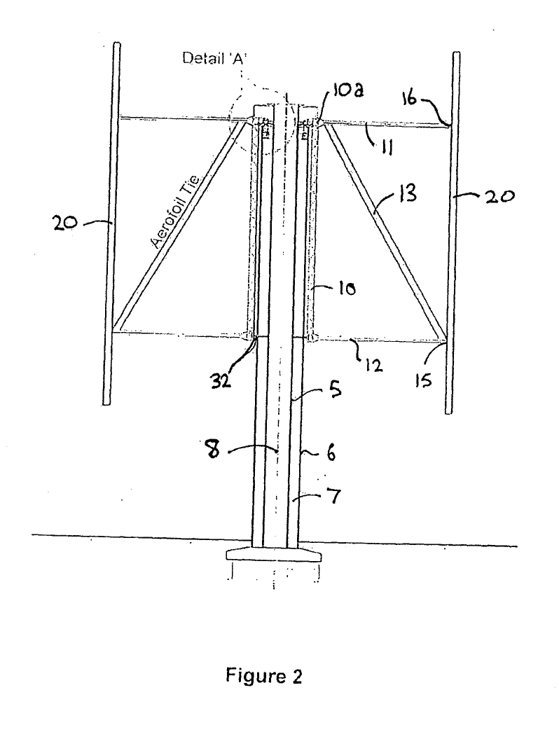

In a first particular embodiment of the invention depicted in FIGS. 1 and 2, the diagonal tie stay component 13 of the rotor arms is enclosed in an aerodynamically shaped skin. This effectively converts the tie stay component 13 into an additional diagonal aerofoil blade inclined obliquely to the tower 4 and the upright blades 20 that are spaced around the periphery of the rotor 2. Opposing ends of the diagonal tie stays 13 are fixed at or near respective inner and outer ends 14, 15 of the radially-extending rotor arms 11, 12. This reduces the drag caused by the tie stay component and also improves the aerodynamic effectiveness of the aerofoil blades by reducing the disturbance of the air flow of the inner side of the aerofoil blade and airflow in between the aerofoil blade and the carousel caused by the tie stayed component. Further, the aerodynamically shaped tie stayed component acts as an additional aerofoil blade which will assist in the self-starting of the rotor and improve the rotation of the rotor in low wind conditions.

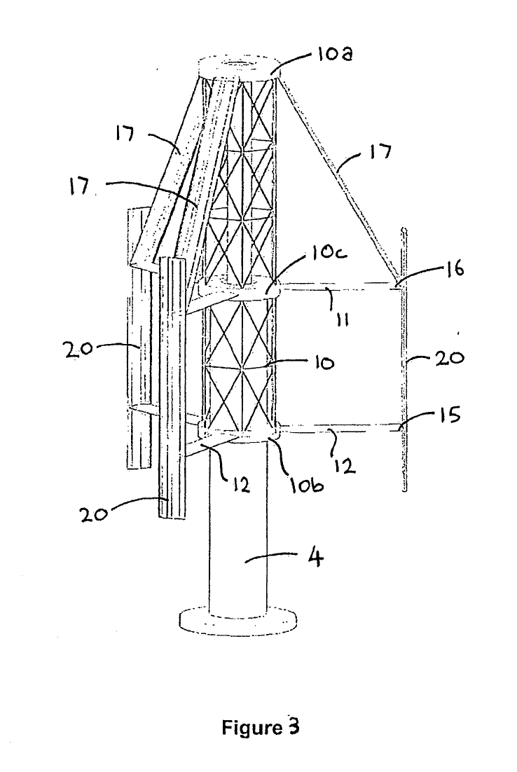

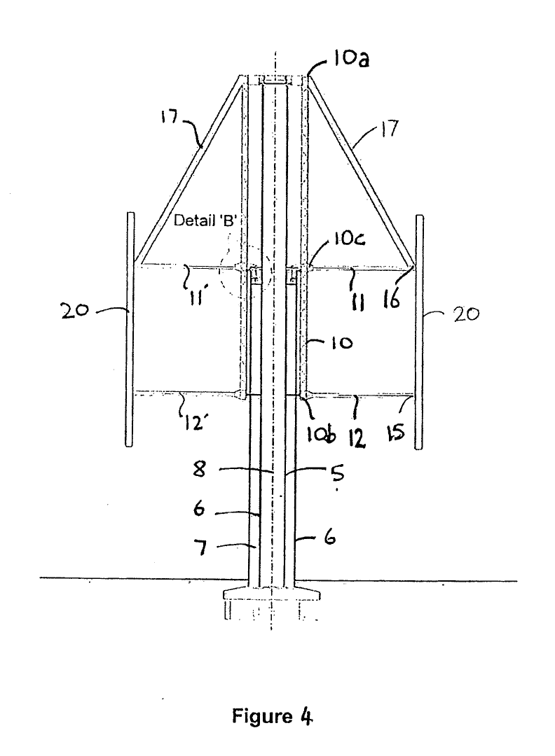

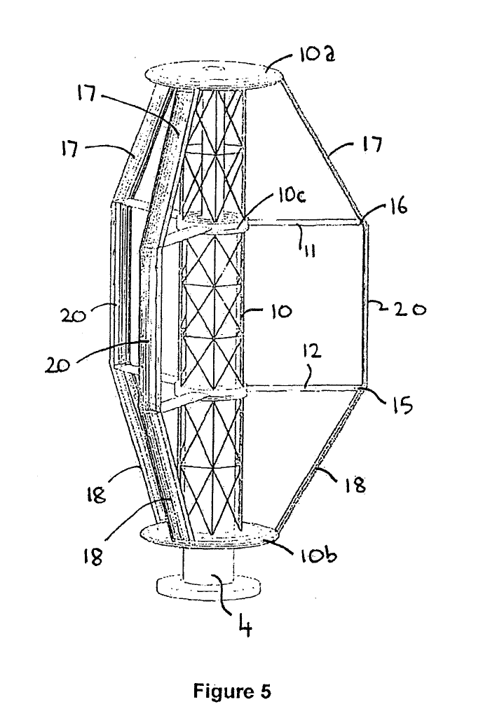

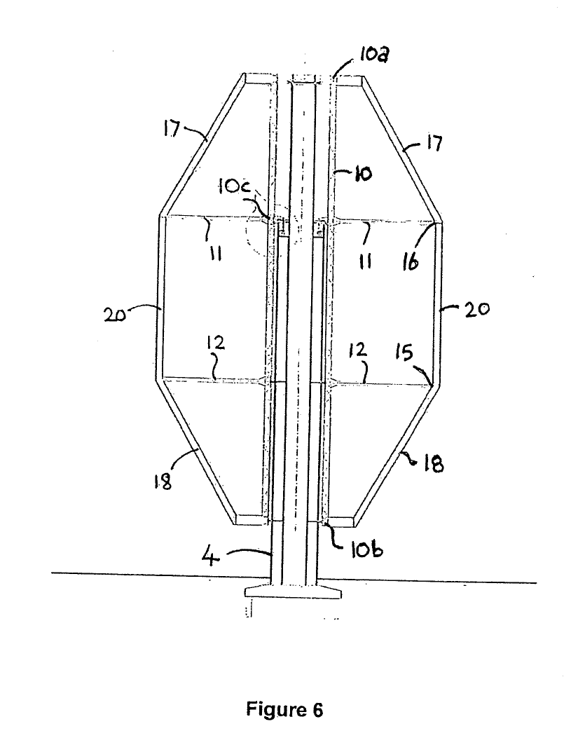

In a second and third particular embodiments of the invention depicted in FIGS. 3 through 6, there is no diagonal tie stay component in between the upper and lower radially extending rotor arms 11, 12. Instead an additional diagonal aerofoil blade 17 is inclined obliquely and a first angle between the top 10a of the carousel 10 and the distal end 16 of the upper rotor arm 11. This diagonal aerofoil blade 17 increases the rotational torque of the rotor 2 for a given wind speed and will assist in the self-starting of the rotor and improve the rotation of the rotor in low wind conditions. It also provides the structural strength needed to counter the gravitational and centrifugal forces acting on the vertical blades 20. In addition some configurations may include a third aerofoil blade 18 inclined obliquely at a second angle, which is complimentary to the first angle. The third blade 18 is diagonally affixed between the bottom 10b of the carousel 10 and a position proximate the distal end 15 of the lower rotor arm 12 to form a generally trapezoidal troposkein blade configuration, which provides good gravitational and centrifugal force distribution in the blade.

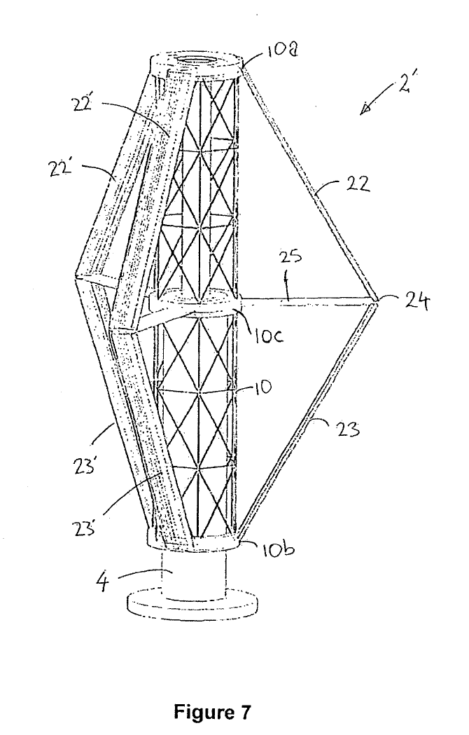

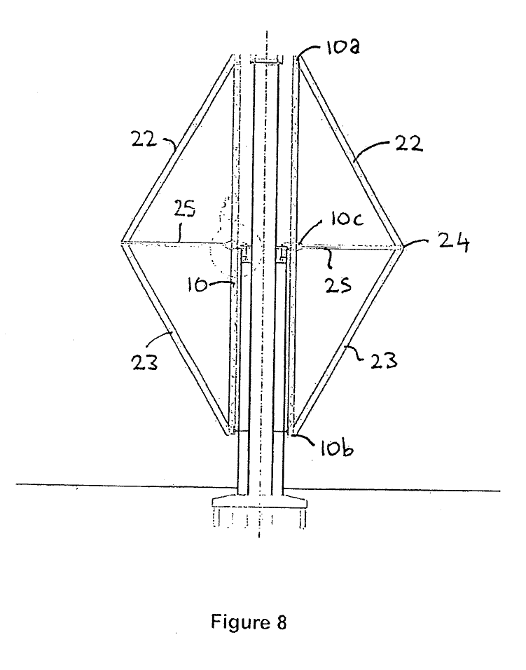

In a fourth particular embodiment of the current invention, depicted in FIGS. 7 and 8, the rotor comprises a fully trussed tubular carousel structure 10 rotatably supported about a stationary vertical hollow core 4 with aerodynamic blades of a generally triangular configuration extending radially from the carousel 10. Each blade comprises two obliquely inclined blade sections 22, 23 arranged in a generally triangular configuration. A first straight blade section 22 is attached at one end either directly, or by a short connector, to the top 10a of the carousel 10 and a second straight blade section 23 is attached at one end either directly, or by a short connector, to the bottom 10b of the carousel 10. The two straight blade sections 22, 23 meet at a horizontal apex 24. A single horizontal radial strut 25 joins the apex 24 to the centre 10c of the carousel 10. The blade sections 22, 23 are in an aerofoil shape. Optionally, the horizontal radial strut 25 may also have an aerofoil shape.

The blades 22, 23 are connected to the carousel 10 by a simple arrangement of upper and lower connectors and a central radial strut 25 which transfer the blade forces into the carousel 10. The trangular configuration provides superior performance in terms of gravitational and centrifugal forces on the blades 22, 23 allowing for smaller support members resulting in lower drag.

In the preferred embodiment the rotor has three such triangular blades equidistantly located about its circumference (this is not intended to limit the scope of use of functionality of the invention and skilled addressee will appreciate that 2, 4, 5, 6 or more blades may be used with varying degrees of power and efficiency). In practice this double oblique blades results in a three dimensional triangular structure about a tubular cylindrical carousel. This provides a very rigid rotor structure which helps minimize undesirable rotational stresses on the blades themselves.

The blade sections 13, 17, 18, 20, 22, 23 may be made of fiber reinforced resin formed in an aerofoil shape by a Pultrusion technique. Alternatively the blades may be made from a lightweight polymer material formed by suitable techniques. All of the blades sections 13, 17, 18, 20, 22, 23 are made from lightweight materials and are straight between their ends and have a uniform aerofoil shape in cross section, which simplifys the manufacturing and design processes.

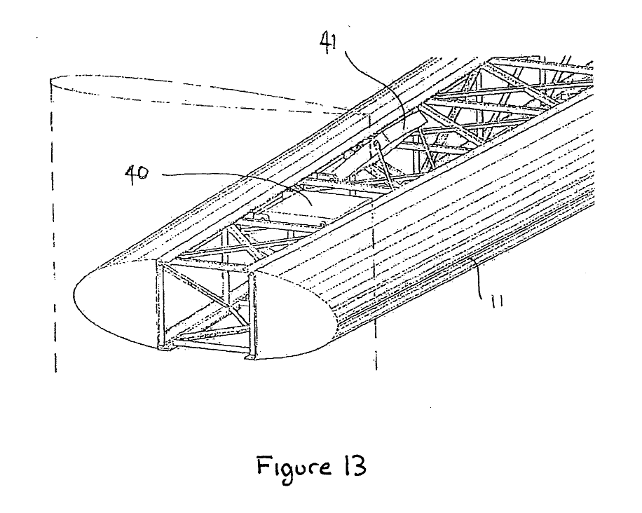

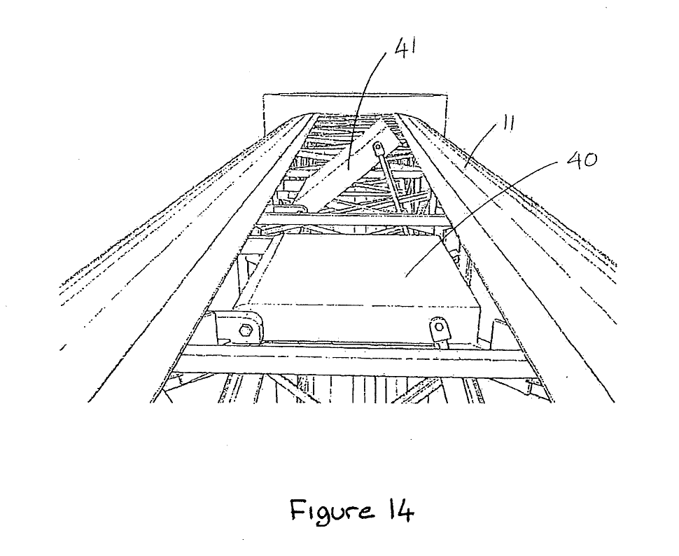

It is envisaged by the inventors that a flap 40, 41 device may be provided on the aerodynamically shaped rotor arms to assist the start up, to control the rotational speed and/or to stop the rotor 2 by disrupting airflow over the aerofoil. In order to assist the start up, control the speed of rotation of the rotor and stop the generator, the inventors have in the current invention provided the flap devices 40, 41, using part of the aerodynamically shaped skin of the rotor arms as flaps, which can be raised, as depicted by flap 41, or lowered, as depicted by flap 40, by manual control or by automated controlling devices shown in FIGS. 13 and 14. The raising of the flaps can be motor driven or by hydraulic devices or by any other mechanical means or devices or by a combination of them.

There can be one or more flap devices on each rotor arm. The flap plate 40, 41 is hinged at one end to the aerodynamically shaped rotor arms and the other end is free to be raised. The free end of the flap to be raised can be facing the direction of the rotation of the rotor or facing the direction counter to the direction of the rotation of the rotor. The flap devices 40, 41 can be on all or only some, but not all of the rotor arms. The flap devices 40, 41 can be all raised in one direction or be a combination with some flap or flaps to be raised in the direction facing the rotational direction of the rotor and some flap or flaps to be raised facing the direction counter to the rotational direction of the rotor.

At low wind speeds the flaps 41, 41, or some of them, can be raised up to an appropriate angle to function as drag type blades to assist start up or rotation. At higher wind speeds when the main aerofoil blades at the distal end of the rotor arms are functioning fully as aerofoil blades, the flaps 40, 41 will be lowered and thus the drag type blades will be withdrawn and rotor arms will be just aerodynamically shaped blades or wings to reduce drag caused by the rotor arms. In high wind speed when the speed of rotation of the rotor exceeds its desirable speed, the flaps 40, 41 can be raised again to the appropriate angle to reduce the speed of the rotor by creating drag. In cases where it is desirable to stop the generator, the flaps 40, 41 can be raised to the appropriate angle to cause drag or force counter to the rotation direction of the generator to act as a type of air brake or at least in assisting the braking of the generator.

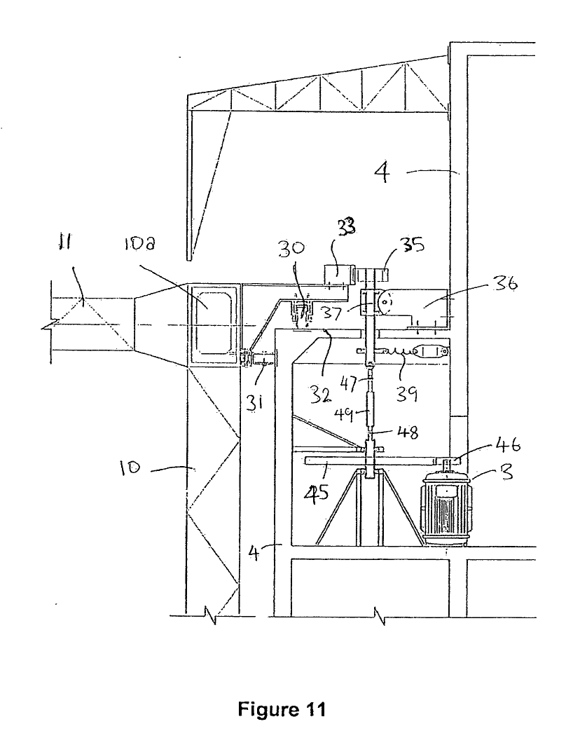

Movement of the rotor is used to mechanically turn a generator 3 located with the core tower 4 by means of a circular rack and pinion gearing arrangement. As described in PCT/IB2008/003521 the outer wall of the core tower is stepped to a provide a ledge 32 about the outer periphery of the core tower 4. Referring to FIG. 11, a large ring gear 33 is located on an inner surface of the rotor carousel 10 and extends to a space over the top part of the core tower or a step/ledge 32 of the core tower at an appropriate place corresponding with the location of the ring gear. A vertically mounted torque transmission shaft 34 extends vertically through an opening in the step/ledge 32 or top part of the core wall and has affixed to its top end a pinion gear 35 which engages with the inner surface of the ring gear 33. Rotation of the carousel turns the torque transmission shaft 34 via the ring gear 33 and pinion 35.

During rotation of the carousel there may be lateral movement between the carousel 10 and core wall 4. The torque transmission shaft 34 is pivotally mounted and biased to maintain positive driving engagement between the ring gear and pinion. A bracket 36 is mounted to the inside of the core wall and has pivotally attached to its distal end a bearing sleeve 37 through which the torque transmission shaft 34 is rotationally supported by one or more bearings. The bearing sleeve 37 and torque transmission shaft 34 can pivot allowing the pinion 35 to maintain engagement with the ring gear 33 during lateral movement of the carousel 10. A second bearing sleeve 38 is located on the torque transmission shaft between the pivotal bearing sleeve 37 and pinion 35. The second bearing sleeve 38 is attached to the core wall via a spring 39 or other biasing means in order to exert a biasing force on the vertical shaft 34 to maintain positive engagement between the pinion 35 and ring gear 33.

Rotational torque from the vertical shaft 34 is transferred to a gear set 45, 46 and electric generator 3 via universal, or gimble, joints 47, 48 and telescoping splined shafts 49. The lower end of the torque transmission shaft includes a first universal joint 47. A splined stub shaft of the first universal joint 47 is telescopically received within a splined sleeve 49. The splined sleeve is connected to a second universal joint 48 which couples the splined sleeve to the main gear shaft of the gear set 45. A pinion 46 of the gear set is attached to the electricity generator 3 for transferring rotational torque to the generator 3.

The pair of universal joints 47, 48 with telescoping splined shafts 49 between them allows for pivotal and axial movement of the torque transmission shaft 34. The pair of universal joints 47, 48 allows for lateral movement of the torque transmission shaft 34 and the telescoping splined shafts 49 provide for variations in distance between the universal joints 47, 48 as the distance between the universal joint changes with pivotal movement of the torque transmission shaft 34.

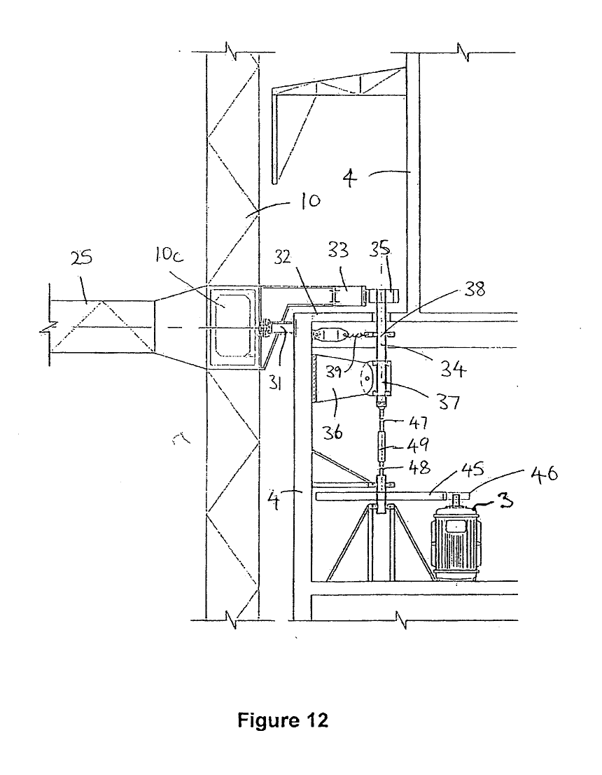

FIG. 12 shows an alternative arrangement of the drive system in which the main ring gear 33 is provided at the top 10a of the rotor carousel. The bracket 36 holding the pivoting bearing holder 37 is located closer to the pinion 35 end of the torque transmission shaft 34 and the biasing bearing holder 38 is located closer to the universal joint 47 end of the torque transmission shaft 34. Other components of the drive system remain the same with the pivoting bearing holder 37 allowing pivoting of the shaft to maintain engagement between the pinion gear 35 and ring gear 33 during lateral movement of the rotor carousel 10. The biasing spring 39 maintains a firm biasing engagement between the pinion gear 35 and ring gear 33 as the carousel 10 moves.

1. A vertical axis wind turbine comprising:
a stationary circular core,
a rotor rotatably supported about the stationary core and having a radially extending rotor arm, and
a wind engaging blade located at a distal end of the radially extending rotor arm, the blade comprising at least first and second straight blade sections of which at least the first straight blade section is inclined obliquely at a first angle.

2. The vertical axis wind turbine of claim 1 wherein the second straight blade section is vertical.

3. The vertical axis wind turbine of claim 2 further including a third straight blade section inclined obliquely at a second angle, the second angle being complementary to the first angle.

4. The vertical axis wind turbine of claim 1 wherein the second straight blade section is inclined obliquely at a second angle, the second angle being complementary to the first angle.

5. The vertical axis wind turbine of claim 1 wherein
the rotor further comprises a tubular carousel structure located and freely rotatable about the core,
the carousel has an upper end and a lower end,
the rotor extends radially from the carousel at a location between the upper and lower ends, and
the first straight blade section is affixed at a proximal end to the upper end of the carousel and is affixed at a distal end proximate the distal end of the rotor arm.

6. The vertical axis wind turbine of claim 1 wherein
the rotor has an upper radially extending rotor arm and a lower radially extending rotor arm, and
the first straight blade section is affixed at a proximal end to a proximal end of the upper radially extending rotor arm and is affixed at a distal end proximate a distal end of the lower radially extending rotor arm.

7. The vertical axis wind turbine of claim 1 wherein each of the first and second straight blade sections is straight between its ends and has an aerofoil shape in cross section.

8. The vertical axis wind turbine of claim 1 wherein at least one of the first and second straight blade sections includes a flap member extendable to disrupt airflow across the blade.

9. The shaftless wind turbine of claim 1 wherein the rotor is mechanically connected to an electric generator.

10. The shaftless wind turbine of claim 9 wherein the rotor is drivably connected to the electric generator via a pair of cooperating gears turning a torque transmission shaft, the torque transmission shaft including an axially movable splined coupling and a pivoting universal joint.

11. A vertical axis wind turbine comprising:
a stationary circular hollow core,
a rotor rotatably supported about the stationary core and having a radially extending rotor arm and a wind engaging blade located at a distal end of the radially extending rotor arm,
an electric generator set located with the stationary core, and
a torque transmission system for transferring rotational torque of the rotor to the generator set, the torque transmission system including a pair of cooperating gears driving a torque transmission shaft coupled to the generator set, wherein the torque transmission shaft includes an axially movable coupling and a pivoting coupling.

12. The vertical axis wind turbine of claim 11 wherein the pair of cooperating gears comprises a ring gear surrounding the core and movable by the rotor, and a pinion gear located on an end of the torque transmission shaft.

13. The vertical axis wind turbine of claim 11 wherein the torque transmission shaft is vertically disposed and biased for positive engagement of the pinion with the ring gear.

14. The vertical axis wind turbine of claim 11 wherein the axially movable coupling is a splined coupling.

15. The vertical axis wind turbine of claim 11 wherein the pivoting coupling is a universal or gimbal joint.
